(19) United States
(12) Patent Application Publication
(10) Pub. No.: US 2023/0274662 A1
(43) Pub. Date: Aug. 31, 2023

(54) DATA PROCESSING METHOD AND APPARATUS, COMPUTER DEVICE, AND STORAGE MEDIUM

(71) Applicant: BEIJING SOGOU TECHNOLOGY DEVELOPMENT CO., LTD., Beijing (CN)

(72) Inventors: Wenjun DUAN, Beijing (CN); Jingrong BI, Beijing (CN); Mei LI, Beijing (CN); Fanbo MENG, Beijing (CN); Yun PENG, Beijing (CN); Kai LIU, Beijing (CN)

(73) Assignee: BEIJING SOGOU TECHNOLOGY DEVELOPMENT CO., LTD., Beijing (CN)

(21) Appl. No.: 18/312,750

(22) Filed: May 5, 2023

Related U.S. Application Data
(63) Continuation of application No. PCT/CN2022/099810, filed on Jun. 20, 2022.

(30) Foreign Application Priority Data
Jul. 20, 2021 (CN) 2021 10821632.4

(51) Int. Cl. G09B 21/00; G06T 17/00; G06T 13/40; G06V 30/148

(52) U.S. Cl. CPC G09B 21/009; G06T 17/00; G06T 13/40; G06V 30/153

(57) ABSTRACT

Provided herein are a data processing method and apparatus, a computer device, and a storage medium for sign language translation. Sign language is translated to text by: obtaining sign language action data; determining a sign language tagging sequence corresponding to the sign language action data by element analysis, and performing operation processing on the sign language action data based on the sign language tagging sequence. Text is translated to sign language by: performing word segmentation processing on a text sequence to obtain a natural word sequence; determining a basic sign language element and an element type corresponding to each natural word in the natural word sequence; sorting the basic sign language element and the element type to generate a sign language element sequence; determining a sign language tagging sequence; and performing sign language translation processing on the text sequence based on the sign language tagging sequence.

### CROSS REFERENCE TO RELATED APPLICATIONS

This application is a bypass continuation application of International Patent Application No. PCT/CN2022/099810, filed on Jun. 20, 2022, which is based on and claims priority to Chinese Patent Application No. 202110821632.4, filed with the China National Intellectual Property Administration on Jul. 20, 2021, the disclosures of which are incorporated by reference herein in their entireties.

### FIELD

This disclosure relates to the field of computer technologies and data processing, and in particular, to a data processing method and apparatus, a computer device, and a storage medium for translation of sign language to and from text.

### BACKGROUND

Sign language is one of the ways for special users who are hearing impaired or unable to speak to communicate, but hearing users usually do not understand the sign language, resulting in difficulties in communication between the special users and ordinary users.

In a conventional method, the ordinary users and the special users may communicate with each other with the assistance of a sign language translation tool or a sign language synthesis tool. However, in actual application, the sign language is used as a visual language. For the same sign language word, there are large differences in sign language actions presented by different performers, and because the general sign language is only recently popularized, there are regional differences between, for example, a northern region and a southern region of a country or continent. As a result, the processing result of the traditional sign language translation tool or sign language synthesis tool is less accurate.

### SUMMARY

In accordance with certain embodiments of the present disclosure, a data processing method, performed by a computer device, is provided. The method includes obtaining to-be-processed sign language action data; determining a sign language tagging sequence corresponding to the sign language action data by performing element analysis on the sign language action data, the element analysis based on a pre-established sign language tagging system, the sign language tagging sequence comprising tagging information of basic sign language elements corresponding to the sign language action data; and performing operation processing on the sign language action data based on the sign language tagging sequence.

In accordance with other embodiments of the present disclosure, another data processing method, performed by a computer device, is provided. The method includes performing word segmentation processing on a to-be-translated text sequence, to obtain a natural word sequence corresponding to the text sequence; determining a basic sign language element corresponding to each natural word in the natural word sequence and an element type corresponding to the basic sign language element; sorting the basic sign language element and the element type, to generate a sign language element sequence conforming to a sign language grammar rule; determining a sign language tagging sequence corresponding to the sign language element sequence based on a sign language tagging system; and performing sign language translation processing on the text sequence based on the sign language tagging sequence, to obtain a sign language action corresponding to the text sequence.

In accordance with other embodiments of the present disclosure, a data processing apparatus is provided. The apparatus includes a memory and one or more processors, and the memory stores computer-readable instructions. The computer-readable instructions, when executed by the one or more processors, cause the one or more processors to perform operations including obtaining to-be-processed sign language action data; determining a sign language tagging sequence corresponding to the sign language action data by performing element analysis on the sign language action data, the element analysis based on a pre-established sign language tagging system, the sign language tagging sequence comprising tagging information of basic sign language elements corresponding to the sign language action data; and performing operation processing on the sign language action data based on the sign language tagging sequence.

In accordance with other embodiments of the present disclosure, another data processing apparatus is provided. The apparatus includes a memory and one or more processors, and the memory stores computer-readable instructions. The computer-readable instructions, when executed by the one or more processors, cause the one or more processors to perform operations including performing word segmentation processing on a to-be-translated text sequence, to obtain a natural word sequence corresponding to the text sequence; determining a basic sign language element corresponding to each natural word in the natural word sequence and an element type corresponding to the basic sign language element; sorting the basic sign language element and the element type, to generate a sign language element sequence conforming to a sign language grammar rule; determining a sign language tagging sequence corresponding to the sign language element sequence based on a sign language tagging system; and performing sign language translation processing on the text sequence based on the sign language tagging sequence, to obtain a sign language action corresponding to the text sequence.

In accordance with other embodiments of the present disclosure, one or more non-transitory non-volatile computer-readable storage media, storing computer-readable instructions, are provided. The computer-readable instructions, when executed by one or more processors, cause the one or more processors to perform operations including obtaining to-be-processed sign language action data; determining a sign language tagging sequence corresponding to the sign language action data by performing element analysis on the sign language action data, the element analysis based on a pre-established sign language tagging system, the sign language tagging sequence comprising tagging information of basic sign language elements corresponding to the sign language action data; and performing operation processing on the sign language action data based on the sign language tagging sequence.

In accordance with other embodiments of the present disclosure, one or more other non-transitory non-volatile computer-readable storage media, storing computer-readable instructions, are provided. The computer-readable instructions, when executed by one or more processors, cause the one or more processors to perform operations including performing word segmentation processing on a to-be-translated text sequence, to obtain a natural word sequence corresponding to the text sequence; determining a basic sign language element corresponding to each natural word in the natural word sequence and an element type corresponding to the basic sign language element; sorting the basic sign language element and the element type, to generate a sign language element sequence conforming to a sign language grammar rule; determining a sign language tagging sequence corresponding to the sign language element sequence based on a sign language tagging system; and performing sign language translation processing on the text sequence based on the sign language tagging sequence, to obtain a sign language action corresponding to the text sequence.

Details of one or more embodiments of this disclosure are provided in the accompanying drawings and descriptions below. Other features, objectives, and advantages will become apparent from the disclosure, the accompanying drawings, and the claims.

### BRIEF DESCRIPTION OF THE DRAWINGS

To describe the technical solutions in the embodiments of this disclosure more clearly, the following briefly describes the drawings for accompanying the descriptions of the embodiments of this disclosure. It is noted that the accompanying drawings show merely some embodiments of this disclosure, and persons of ordinary skill in the art may still derive other drawings from these accompanying drawings without creative efforts.

FIG. 1A is a diagram of an application environment of a data processing method according to an embodiment of the disclosure;

FIG. 1B is a flowchart of a data processing method according to an embodiment of the disclosure;

FIG. 1C is a flowchart of a data processing method according to an embodiment of the disclosure;

FIG. 2A is a structural block diagram of a data processing apparatus according to an embodiment of the disclosure;

FIG. 2B is a structural block diagram of a data processing apparatus according to an embodiment of the disclosure;

FIG. 3 is a schematic structural diagram of a computer device according to an embodiment of the disclosure; and

FIG. 4 is a schematic structural diagram of a computer device according to an embodiment of the disclosure.

### DETAILED DESCRIPTION

The following clearly and completely describes the technical solutions in embodiments of this disclosure with reference to the accompanying drawings. It is noted that the described embodiments include some but not all embodiments. All other embodiments obtained by persons of ordinary skill in the art based on the embodiments of this disclosure without creative efforts shall fall within the protection scope of this disclosure.

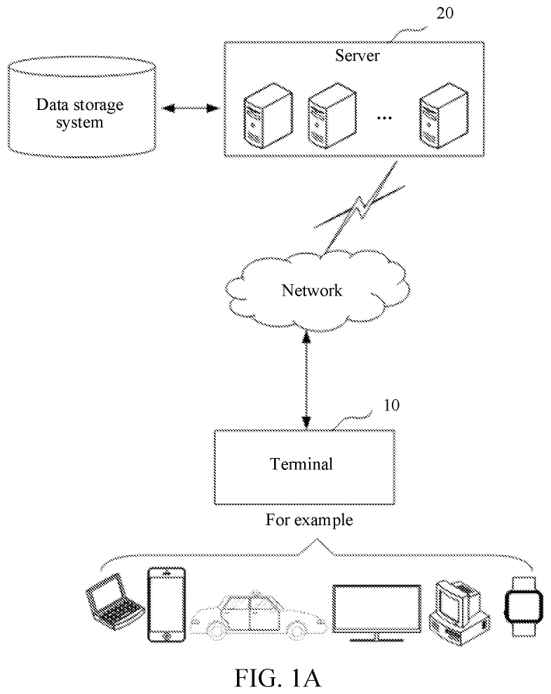

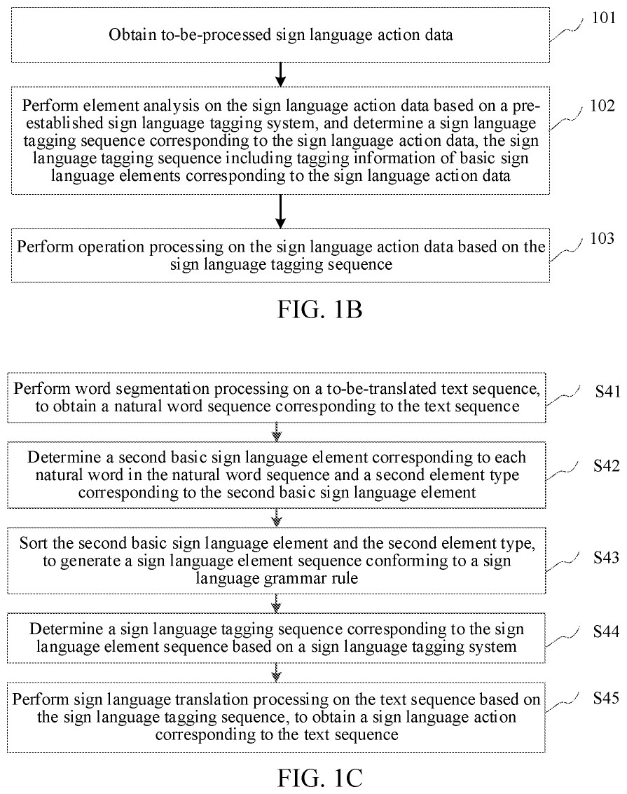

A data processing method according to an embodiment of this disclosure may be applied to an application environment shown in FIG. 1A. A terminal 10 communicates with a server 20 through a network. A data storage system may store data for processing by the server 20. The data storage system may be integrated on the server 20, or may be placed on a cloud or another server.

Specifically, the terminal 10 obtains to-be-processed sign language action data, performs element analysis on the sign language action data based on a pre-established sign language tagging system, and determines a sign language tagging sequence corresponding to the sign language action data, the sign language tagging sequence including tagging information of basic sign language elements corresponding to the sign language action data, and performs operation processing on the sign language action data based on the sign language tagging sequence. The terminal 10 may obtain the pre-established sign language tagging system from the server 20, and may send the sign language tagging sequence to the server 20, and the server 20 may store the sign language tagging sequence.

In some embodiments, the terminal 10 may send a sign language action data processing request to the server 20, the sign language action data processing request carries the to-be-processed sign language action data, and the server 20 may obtain the to-be-processed sign language action data from the sign language action data processing request, perform element analysis on the sign language action data based on the pre-established sign language tagging system, determine the sign language tagging sequence corresponding to the sign language action data, the sign language tagging sequence including tagging information of the basic sign language elements corresponding to the sign language action data, and perform operation processing on the sign language action data based on the sign language tagging sequence. The server 20 may send the sign language tagging sequence to the terminal 10, and may further store the sign language tagging sequence.

The terminal 10 may be, but is not limited to, a desktop computer, a notebook computer, a smartphone, a tablet computer, an Internet of Things device, or a portable wearable device. The Internet of Things device may be a smart speaker, a smart television, a smart air conditioner, a smart vehicle-mounted device, or the like. The portable wearable device may be a smart watch, a smart bracelet, a head-mounted device, or the like. The server 20 may be implemented by using an independent server or a server cluster that comprises a plurality of servers.

The data processing method provided in this embodiment of this disclosure may be applied to a terminal device, or may be applied to a server. The terminal may include, but is not limited to: a dedicated sign language translation device, a sign language action synthesis device, a smart terminal, a computer, a personal digital assistant (PDA), a tablet computer, an e-book reader, a Moving Picture Experts Group Audio Layer III (MP3) player, a Moving Picture Experts Group Audio Layer IV (MP4) player, a laptop portable computer, a vehicle-mounted device, a smart television, a wearable device, and the like.

The server may be an independent physical server, or may be a server cluster or a distributed system formed by a plurality of physical servers, or may be a cloud server that provides basic cloud computing services such as a cloud service, a cloud database, cloud computing, a cloud function, cloud storage, cloud communication, a network service, a middleware service, a content delivery network (CDN), big data, and an AI platform.

### Method Embodiments

FIG. 1B is a flowchart of a data processing method according to an embodiment of this disclosure. The method may be performed by a terminal or a server, or may be performed by the terminal and the server jointly. Descriptions are made by using an example in which the method is applied to a terminal 10 in FIG. 1A, and the data processing method may specifically include the following operations:

Operation 101: Obtain to-be-processed sign language action data.

The sign language action data is data related to a sign language action, and may include, but is not limited to, at least one of a descriptive text or a picture about the sign language action, a sign language action video, and a sign language animation. The sign language action data obtained in this embodiment of this disclosure may be at least one of a sign language video and a sign language picture that include a sign language action. The sign language video or the sign language picture may be a video or a picture photographed by a terminal device through a photographing device when a target object communicates with others or a machine or transmits information to others by sign language, may be a sign language video or a sign language picture stored in the terminal device and/or server, or may be a sign language video or a sign language picture downloaded from a network side. The target object may include, but is not limited to, at least one of people with hearing impairment, deaf people, and hearing people.

Operation 102: Perform element analysis on the sign language action data based on a pre-established sign language tagging system, and determine a sign language tagging sequence corresponding to the sign language action data, the sign language tagging sequence including tagging information of basic sign language elements corresponding to the sign language action data.

The sign language tagging system established in this embodiment of this disclosure includes basic sign language elements corresponding to the sign language actions, and the basic sign language elements include at least one of a left or right arm feature, a one or both handshape feature, an orientation motion feature, a knuckle bending angle, a facial expression feature, and constraint information. Different basic sign language elements represent sign language action features of different dimensions. The basic sign language element may be understood as a minimum feature unit of a sign language action, and any sign language action may include one or more basic sign language elements. Each basic sign language element includes at least one element type. For example, in an exemplary sign language tagging system of this disclosure, the one or both hand shape feature is corresponding to 67 different element types, the orientation motion feature is corresponding to 66 different element types, the constraint information is corresponding to 57 different element types, and the facial expression feature is corresponding to 8 different element types. The terminal may perform permutation and combination on different types of basic sign language elements, to obtain different sign language actions.

The sign language tagging system further includes the basic sign language elements and tagging information corresponding to the element types of the basic sign language element. The tagging information of each basic sign language element corresponding to the to-be-processed sign language action data, that is, the sign language tagging sequence corresponding to the sign language action data, can be determined based on the sign language tagging system. The sign language tagging sequence includes the tagging information of the basic sign language elements corresponding to the sign language action data.

The tagging information is used for uniquely identifying the element types of each basic sign language element, and the tagging information may be identified by a machine, has wide representativeness and universality, and is applicable to most sign language application scenarios.

In some embodiments, the sign language tagging sequence may further include timestamps corresponding to the basic sign language elements of the sign language action data, making it convenient to determine a processing sequence of the basic sign language elements based on the timestamps corresponding to the basic sign language elements when performing operation processing on the sign language action data. For example, a digital character may be driven, based on the tagging information and the timestamps of the basic sign language elements in the sign language tagging sequence, to perform a sign language action corresponding to the sign language action data. Herein, the term “digital character” refers to a three-dimensional character model constructed by using 3D technologies.

Operation 103: Perform operation processing on the sign language action data based on the sign language tagging sequence.

The operation processing may include, but is not limited to, at least one of translation processing on the sign language action data or performing the sign language action corresponding to the sign language action data.

Specifically, the terminal may drive, based on the sign language tagging sequence, the pre-constructed three-dimensional character model to perform the sign language action corresponding to the sign language action data, or the terminal may perform sign language translation processing on the sign language action data based on the sign language tagging sequence, to obtain content in a text form corresponding to the sign language action data.

In the foregoing data processing method, after the to-be-processed sign language action data is obtained, element analysis on the sign language action data is performed based on the pre-established sign language tagging system, sign language tagging sequence corresponding to the sign language action data is determined, the sign language tagging sequence including the tagging information of the basic sign language elements corresponding to the sign language action data, and then operation processing on the sign language action data is performed based on the sign language tagging sequence. In this way, element analysis on the sign language action data is performed based on the pre-established sign language tagging system, and the basic sign language elements included in the sign language action data are determined, that is, the to-be-processed sign language action data is disassembled into minimum feature units to be applicable to analysis processing of various sign language action data and conducive to increasing accuracy of analyzing the sign language action data. In addition, in this embodiment of this disclosure, by determining the tagging information of the basic sign language elements in the sign language action data, the sign language action data is converted into the sign language tagging sequence that can be automatically identified by the machine, and then operation processing on the sign language action data is performed based on the sign language tagging sequence, thereby increasing processing efficiency and accuracy of the sign language action data.

In an optional embodiment of this disclosure, before operation 102: perform element analysis on the sign language action data based on a pre-established sign language tagging system, the data processing method further includes:

Operation S11: Perform disassembly and classification on sign language action data in a database, to obtain basic sign language elements and element types corresponding to each basic sign language element.

Operation S12: Establish a sign language tagging system based on the basic sign language elements and the element types corresponding to each basic sign language element, the sign language tagging system including tagging information corresponding to the element types of each basic sign language element.

The sign language action data in the database includes sign language action data for interaction in daily lives and sign language action data dedicated in professional fields. The sign language action data may be at least one of a descriptive text or a picture about a sign language action, a sign language action video, and a sign language animation. A sign language action database may be established by widely searching for various sign language action materials, such as sign language teaching videos, Internet sign language materials, sign language dictionaries, and the like.

Specifically, the terminal may perform disassembly and classification on all sign language action data in the database, determine all basic sign language elements involved in the database and the element types corresponding to each basic sign language element, and determine the tagging information corresponding to the element types of each basic sign language element, to establish the sign language tagging system. The tagging information is used for uniquely identifying the element types of each basic sign language element, and the tagging information may be identified by the machine, has wide representativeness and universality, and is applicable to most sign language application scenarios. For example, the terminal may perform disassembly and classification on all sign language action data in the database based on a linguistics framework.

In this embodiment, the sign language action data in the database is disassembled and classified to obtain the basic sign language elements and the element types corresponding to each basic sign language element, and the sign language tagging system is established based on the basic sign language elements and the element types corresponding to each basic sign language element, thereby increasing accuracy of the established sign language tagging system.

In some embodiments, the basic sign language elements include at least one of a left or right arm feature, a one or both handshape feature, an orientation motion feature, a knuckle bending angle, a facial expression feature, and constraint information.

The left or right arm feature may include a bending angle of the arms, a state of rising or droop, and another arm feature in the sign language action. The one or both handshape feature may include shapes and gesture features of fingers. The orientation motion feature may include palm orientations, motion states of the arms and palms, and another feature. The knuckle bending angle is used for indicating bending angles of knuckles of the fingers, for example, the third knuckle of the left index finger bends at 45°. Herein, the term “facial expression feature” refers to a specific facial expression in sign language action, such as a smile, upset, or surprise. The constraint information may include a contact state of a key part and specific time limitation in the sign language action, or other information. For example, in the sign language action of the sign language word “love”, the constraint information is “the right palm is in contact with the top knuckle of the left thumb”, or in the sign language action of the sign language word “red”, the constraint information is “the right index finger and the middle finger touch the lip”.

Different basic sign language elements represent sign language action features of different dimensions, and each basic sign language element is corresponding to a plurality of element types. For example, in an exemplary sign language tagging system of this disclosure, the one or both hand shape feature is corresponding to 67 different element types, the orientation motion feature is corresponding to 66 different element types, the constraint information is corresponding to 57 different element types, and the facial expression feature is corresponding to 8 different element types. The terminal may perform permutation and combination on different types of basic sign language elements, to obtain different sign language actions.

The sign language tagging system in this embodiment of this disclosure may be continually extended and improved. The more detailed the sign language tagging system and the more comprehensive the contained data, the more conducive to improving the efficiency of processing the sign language action data.

In some embodiments, the sign language action database may be further established and improved based on the sign language tagging system established in this embodiment of this disclosure, to decrease establishment costs of the sign language database, extend data coverage range of the sign language database, and provide reliable linguistics theoretical basis for processing operations of the sign language action data, such as sign language synthesis and sign language translation. In this embodiment, because the basic sign language elements include at least one of the left or right arm feature, the one or both handshape feature, the orientation motion feature, the knuckle bending angle, the facial expression feature, and the constraint information, the basic sign language elements cover a wide range, and application scenarios of the data processing method are widened.

In an optional embodiment of this disclosure, operation S11: perform disassembly and classification on sign language action data in a database, to obtain basic sign language elements and element types corresponding to each basic sign language element includes:

Sub-operation S111: Traverse the sign language action data in the database, perform action disassembly on the sign language action data, and determine a key part corresponding to each piece of the sign language action data and an action feature of the key part.

The key part may include at least one of arms, palms, fingers, or a face, and the action feature may include at least one of rotation data, displacement data, a bending angle, a key feature, and an expression feature.

Sub-operation S112: Perform, based on the linguistics framework, classification processing on the key part corresponding to each piece of the sign language action data in the database and the action feature of the key part, to obtain at least two class clusters, each class cluster corresponding to one basic sign language element.

Sub-operation S113: Determine, based on an action feature included in each class cluster, element types of a basic sign language element corresponding to the class cluster.

Specifically, for the various sign language action data in the database, the terminal may perform action disassembly one by one, and determine a key part corresponding to each piece of the sign language action data and action features of the key parts. The key part may include a part such as arms, palms, fingers, or a face, and the action feature may include at least one of rotation data, displacement data, a bending angle, a key feature, and an expression feature.

In some embodiments, the terminal may perform classification on all the key parts obtained by disassembly and the action features of the key parts, to obtain a plurality of class clusters, each class cluster corresponding to one basic sign language element. For example, by disassembling the sign language action data, the sign language action feature may be divided into six dimensions that are respectively a left or right arm feature, a one or both handshape feature, an orientation motion feature, a knuckle bending angle, a facial expression feature, and constraint information. The left or right arm feature may include a bending angle of the arms, a state of rising or droop, and another arm feature in the sign language action. The one or both handshape feature may include shapes and gesture features of fingers. The orientation motion feature may include palm orientations, motion states of the arms and palms, and another feature. The knuckle bending angle is used for indicating bending angles of knuckles of the fingers, for example, the third knuckle of the left index finger bends at 45°. The facial expression feature is a specific facial expression in sign language action, such as a smile, upset, or surprise. The constraint information may include a contact state of a key part and specific time limitation in the sign language action, or other information. For example, in the sign language action of the sign language word “love”, the constraint information is “the right palm is in contact with the top knuckle of the left thumb”, or in the sign language action of the sign language word “red”, the constraint information is “the right index finger and the middle finger touch the lip”.

In some embodiments, after determining the class cluster corresponding to each basic sign language element, the terminal may determine, based on an action feature included in each class cluster, element types of a basic sign language element corresponding to the class cluster. Specifically, the terminal may use each action feature in each class cluster as an element type. The terminal may perform permutation and combination on the basic sign language elements and the element types, so as to conveniently represent the sign language actions based on a result of the permutation and combination.

In this embodiment, the element types of the basic sign language elements are determined in a manner of classification processing, thereby increasing accuracy of determining the element types.

In some embodiments, the action feature includes at least one of rotation data, displacement data, a bending angle, a key feature, and an expression feature.

In this embodiment, because the action feature includes at least one of the rotation data, the displacement data, the bending angle, the key feature, and the expression feature, the action feature covers a wide range, and application scenarios of the data processing method are widened.

In an optional embodiment of this disclosure, operation 102: perform element analysis on the sign language action data based on a pre-established sign language tagging system, and determine a sign language tagging sequence corresponding to the sign language action data includes:

Operation S21: Perform element analysis on the sign language action data, and determine a first basic sign language element corresponding to the sign language action data, and a first element type and a first timestamp of the first basic sign language element.

Operation S22: Determine, based on the pre-established sign language tagging system, first tagging information of the first basic sign language element and second tagging information of the first element type.

Operation S23: Determine, based on the first timestamp, the first tagging information, and the second tagging information, the sign language tagging sequence corresponding to the sign language action data.

Specifically, after obtaining the to-be-processed sign language action data, the terminal may first perform element analysis on the sign language action data, and determine basic sign language elements included in the sign language action data and the element types of the basic sign language elements, that is, determine the first basic sign language element, the first element type of the first basic sign language element, and the first timestamps of the first basic sign language elements. The terminal may analyze the first basic sign language element and the first element type in the sign language action data, to determine minimum feature units of the sign language action data, making it convenient to perform analysis processing on the sign language action data subsequently.

In some embodiments, the sign language tagging system includes tagging information corresponding to each basic sign language element and the element types, that is, and the sign language tagging system constructs tagging standards of the sign language action data that can be applied to any scenario and any sign language action data, and has wide applicability. The terminal can search, in the sign language tagging system, the first tagging information of the first basic sign language elements in the sign language action data and the second tagging information of the first element types, to generate the sign language tagging sequence of the sign language action data based on the first tagging information and the second tagging information. The sign language tagging sequence is corresponding to the sign language action data one to one, and the sign language action corresponding to the sign language action data can be determined based on the sign language tagging sequence. In addition, the sign language tagging sequence can be identified by the machine, so that the terminal can perform sign language translation processing and sign language synthesis processing on the sign language action data based on the sign language tagging sequence of the sign language action data.

For example, for the sign language word “love”, element analysis is first performed, corresponding basic sign language elements and element types corresponding to the basic sign language elements are determined, and then corresponding tagging information is determined based on the sign language tagging system, specifically as shown in Table 1.

TABLE 1

| Basic sign | | Tagging |
|---|---|---|
| language elements | Element types | information |
| One or both | The left thumb rises in vertical, | T0 |
| handshape feature | and the other four fingers are in | |
| | the shape of a fist | |
| | The five fingers of the right hand | T0_O60, |
| | is straight and close together | IMRP0 |
| Motion feature | The left arm is oblique | Still_03 |
| | The right arm is shifted backwards | Straight_06 |
| Constraint | The right palm is in contact with | C (DR, T4L) |
| information | the top knuckle of the left thumb | |
| Orientation feature | The left palm faces right | OR_L_right |
| | The right palm faces down | OR_R_down |
| Facial expression | Smile | smile |
| feature | | |

Based on the tagging information corresponding to the basic sign language elements and the element types in Table 1, the sign language tagging sequence of the sign language word “love” can be determined. The tagging information shown in Table 1 is merely used as an example, and does not constitute limitations to a corresponding relationship between the tagging information of the sign language tagging system and the basic sign language elements or to a corresponding relationship between the tagging information and the element types in this embodiment of this disclosure, and corresponding tagging standards can be formulated according to actual requirements. Such is not limited in this disclosure.

In this embodiment, element analysis is performed on the sign language action data, the first basic sign language element corresponding to the sign language action data, and the first element type and the first timestamp of the first basic sign language element are determined, the first tagging information of the first basic sign language element and the second tagging information of the first element type are determined based on the pre-established sign language tagging system, and the sign language tagging sequence corresponding to the sign language action data is determined based on the first timestamp, the first tagging information, and the second tagging information, so that the sign language tagging sequence covers both the tagging information and the timestamp, and the sign language tagging sequence can accurately represent the sign language action, thereby increasing expressiveness of the sign language tagging sequence.

In an optional embodiment of this disclosure, operation 103: perform operation processing on the sign language action data based on the sign language tagging sequence includes: drive, based on the sign language tagging sequence, the pre-established three-dimensional character model to perform the sign language action corresponding to the sign language action data.

Specifically, after determining the sign language tagging sequence of the to-be-processed sign language action data, the terminal may further drive, based on the sign language tagging sequence, the three-dimension character model to perform the sign language action corresponding to the sign language action data, that is, to synthesize the sign language action by 3D technologies.

In this embodiment, the pre-established three-dimensional character model is driven, based on the sign language tagging sequence, to perform the sign language action corresponding to the sign language action data, so that the three-dimension character model can be controlled, by using the sign language tagging sequence obtained by analyzing, to perform the sign language action, thereby improving flexibility of the three-dimensional character model to perform the sign language action.

In some embodiments, operation 103: perform operation processing on the sign language action data based on the sign language tagging sequence includes: perform sign language translation processing on the sign language action data based on the sign language tagging sequence, to obtain a target text sequence corresponding to the sign language action data.

The target text sequence is content in a text form obtained by translating the sign language action data, the target text sequence and the sign language action data may represent a consistent meaning, and the target text sequence represents the meaning of the sign language action data by words or sentences of a certain language. For example, the target text sequence corresponding to the sign language action data corresponding to “love” may be the word “love” in Chinese.

Specifically, the terminal may perform sign language translation processing on the sign language action data based on the sign language tagging sequence. For example, the terminal may input the sign language tagging sequence into a pre-trained sign language translation model, to obtain a target text sequence corresponding to the sign language action data. The terminal may train the sign language translation model based on the sign language tagging system established in this disclosure, and the trained sign language translation model can accurately identify the sign language actions corresponding to the sign language tagging sequences, to translate the identified sign language actions, thereby improving accuracy of the sign language translation.

In this embodiment, sign language translation processing on the sign language action data is performed based on the sign language tagging sequence, to obtain the target text sequence corresponding to the sign language action data, so that the sign language action data can be translated by using the sign language tagging sequence, thereby improving the accuracy of the translation.

In addition to translating the sign language action data into the target text sequence, the terminal may further perform analysis processing on the text sequence based on the sign language tagging system of this disclosure, to convert the text sequence into a corresponding sign language action.

In some embodiments, as shown in FIG. 1C, a data processing method is provided. The method may be performed by a terminal or a server, or may be performed by the terminal and the server jointly. Descriptions are made by using an example in which the method is applied to a terminal, and the method specifically includes the following operations: Operation S41: Perform word segmentation processing on a to-be-translated text sequence, to obtain a natural word sequence corresponding to the text sequence. Operation S42: Determine a second basic sign language element corresponding to each natural word in the natural word sequence and a second element type corresponding to the second basic sign language element. Operation S43: Sort the second basic sign language element and the second element type, to generate a sign language element sequence conforming to a sign language grammar rule. Operation S44: Determine a sign language tagging sequence corresponding to the sign language element sequence based on a sign language tagging system. Operation S45: Perform sign language translation processing on the text sequence based on the sign language tagging sequence, to obtain a sign language action corresponding to the text sequence.

The language of the to-be-translated text sequence may be at least one of Chinese, English, and Korean, and the language of the text sequence is not limited in this disclosure. When converting the text sequence into the sign language action, the terminal may convert texts of various languages into sign language actions of corresponding countries, or may convert a text of a source language into a sign language action of a country corresponding to a target language. The source language and the target language may be preset or specified as required.

Herein, the term “natural words” refers to words used by users able to hear and speak. By using an example in which the language of the to-be-translated text sequence is Chinese, the natural word may be a Chinese word included in The Contemporary Chinese Dictionary, Xinhua Dictionary, and the like.

The natural word is corresponding to a sign language word, and basic sign language elements and element types corresponding to the natural word can be determined according to the sign language word corresponding to the natural word. For example, for the natural word “love”, information of the basic sign language elements of the corresponding sign language word “love” is shown in Table 1. Because there is a sequence between the basic sign language elements and the element types in the sign language action, and correct action can be obtained only based on a corresponding sequence, after determining the basic sign language elements and the element types corresponding to the natural word sequence, the terminal can sort the basic sign language elements and the element types to generate the sign language element sequence. Then, the terminal can determine the sign language tagging sequence corresponding to the sign language element sequence based on the sign language tagging system. For example, based on Table 1, the sign language tagging sequence corresponding to the natural word “love” can be determined as “T0-T0_O60, IMRP0-Still_03-Straight_06-C(DR,T4L)-OR_L_right-OR_R_down-simile”. The terminal can perform sign language translation processing on the text sequence based on the sign language tagging sequence, to obtain a sign language action. The sign language action may be a picture about the sign language action, or may be a demonstration animation of the sign language action. For example, the terminal may determine the sign language sequence corresponding to the text sequence based on a sign language translation model, and convert the sign language word into the sign language tagging sequence, to obtain a corresponding sign language action, or may directly drive, based on the sign language tagging sequence, a three-dimensional character model to perform the corresponding sign language action.

In some embodiments, the terminal may further convert non-text content into a corresponding sign language action. The non-text content may include at least one of a voice or a picture. Specifically, the terminal may perform character recognition processing on a to-be-translated voice, to obtain a text sequence corresponding to the voice, and then perform the foregoing operations S41 to S45 on the obtained text sequence, to obtain a sign language action corresponding to the voice.

In some embodiments, the terminal can perform image recognition and character recognition on a to-be-translated picture, to obtain a text sequence corresponding to the picture, and then perform the foregoing operations S41 to S45 on the obtained text sequence, to obtain a sign language action corresponding to the picture. Content in the picture includes, but is not limited to, at least one of a character, a figure, and an expression.

According to the foregoing data processing method, word segmentation processing is performed on the to-be-translated text sequence, to obtain the natural word sequence corresponding to the text sequence, the second basic sign language element corresponding to each natural word in the natural word sequence and the second element type corresponding to the second basic sign language element are determined, the second basic sign language element and the second element type are sorted to generate the sign language element sequence conforming to the sign language grammar rule, the sign language tagging sequence corresponding to the sign language element sequence is determined based on a sign language tagging system, and sign language translation processing on the text sequence is performed based on the sign language tagging sequence, to obtain a sign language action corresponding to the text sequence. In this way, a method for converting the text sequence into the sign language action is provided, and accuracy of the generated sign language action is improved because the sign language action is generated based on the sign language elements.

For the sake of simple description, the method embodiments are all described as a series of action combinations. However, persons skilled in the art will recognize that the embodiments of this disclosure are not limited by the described action sequence because some operations may be performed in other sequences or simultaneously according to the embodiments of this disclosure. In addition, persons skilled in the art also know that all the embodiments described herein are exemplary embodiments, and the related actions are not necessarily mandatory to the embodiments of this disclosure.

### Apparatus Embodiments

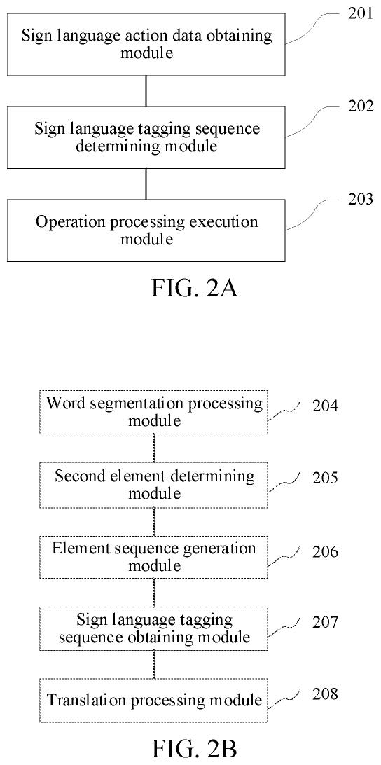

FIG. 2A is a structural block diagram of a data processing apparatus according to an embodiment of this disclosure, and the apparatus may include:
a sign language action data obtaining module 201, configured to obtain to-be-processed sign language action data;
a sign language tagging sequence determining module 202, configured to perform element analysis on the sign language action data based on a pre-established sign language tagging system, and determine a sign language tagging sequence corresponding to the sign language action data, the sign language tagging sequence including tagging information of basic sign language elements corresponding to the sign language action data; and
an operation processing execution module 203, configured to perform operation processing on the sign language action data based on the sign language tagging sequence.

Optionally, the data processing apparatus further includes:
a basic sign language element determining module, configured to perform disassembly and classification on sign language action data in a database, to obtain basic sign language elements and element types corresponding to each basic sign language element; and
a sign language tagging system establishing module, configured to establish a sign language tagging system based on the basic sign language elements and the element types corresponding to each basic sign language element, the sign language tagging system including tagging information corresponding to the element types of each basic sign language element.

Optionally, the basic sign language elements include at least one of a left or right arm feature, a one or both handshape feature, an orientation motion feature, a knuckle bending angle, a facial expression feature, and constraint information.

Optionally, the basic sign language element determining module includes:
an action data analysis submodule, configured to traverse the sign language action data in the database, perform action disassembly on the sign language action data, and determine a key part corresponding to each piece of the sign language action data and an action feature of the key part;
an action feature classification module, configured to perform classification processing on the key part corresponding to each piece of the sign language action data in the database and the action feature of the key part, to obtain at least two class clusters, each class cluster corresponding to one basic sign language element; and
an element type determining submodule, configured to determine, based on an action feature included in each class cluster, element types of a basic sign language element corresponding to the class cluster.

Optionally, the action feature includes at least one of rotation data, displacement data, a bending angle, a key feature, and an expression feature.

Optionally, the sign language tagging sequence determining module includes:
a first element determining sub-module, configured to perform element analysis on the sign language action data, and determine a first basic sign language element corresponding to the sign language action data, and a first element type and a first timestamp of the first basic sign language element;
a tagging information determining sub-module, configured to determine, based on a pre-established sign language tagging system, first tagging information of the first basic sign language element and second tagging information of the first element type; and
a first tagging sequence determining sub-module, configured to determine, based on the first timestamp, the first tagging information, and the second tagging information, the sign language tagging sequence corresponding to the sign language action data.

Optionally, the operation processing execution module includes:
a first operation processing sub-module, configured to drive, based on the sign language tagging sequence, a pre-established three-dimensional character model to perform a sign language action corresponding to the sign language action data.

Optionally, the operation processing execution module includes:
a second operation processing sub-module, configured to perform sign language translation processing on the sign language action data based on the sign language tagging sequence, to obtain a target text sequence corresponding to the sign language action data.

FIG. 2B is a structural block diagram of a data processing apparatus according to an embodiment of this disclosure, and the apparatus may include:
a word segmentation processing module 204, configured to perform word segmentation processing on a to-be-translated text sequence, to obtain a natural word sequence corresponding to the text sequence;
a second element determining module 205, configured to determine a second basic sign language element corresponding to each natural word in the natural word sequence and a second element type corresponding to the second basic sign language element;
an element sequence generation module 206, configured to sort the second basic sign language element and the second element type, to generate a sign language element sequence conforming to a sign language grammar rule;
a sign language tagging sequence obtaining module 207, configured to determine a sign language tagging sequence corresponding to the sign language element sequence based on a sign language tagging system; and
a translation processing module 208, configured to perform sign language translation processing on the text sequence based on the sign language tagging sequence, to obtain a sign language action corresponding to the text sequence.

A computer device includes a memory and one or more processor, the memory storing computer-readable instructions, and the computer-readable instructions, when executed by the processor, causing the one or more processors to perform operations of the foregoing data processing method.

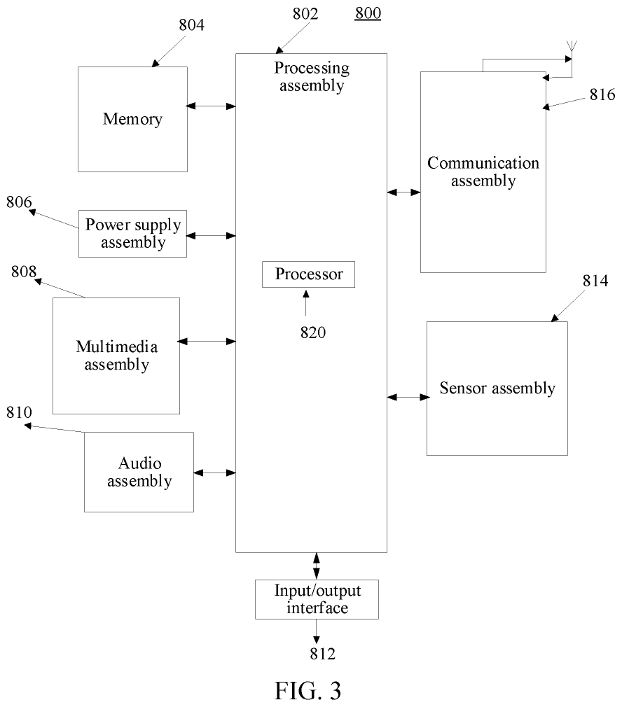

FIG. 3 is a block diagram of a computer device 800 according to an embodiment of the disclosure. For example, the computer device 800 may be a mobile phone, a computer, a digital broadcasting terminal, a message transceiver, a game controller, a tablet device, a medical device, a fitness facility, a personal digital assistant, or the like.

Referring to FIG. 3, the computer device 800 may include one or more assemblies below: a processing assembly 802, a memory 804, a power supply assembly 806, a multimedia assembly 808, an audio assembly 810, an input/output (I/O) interface 812, a sensor assembly 814, and a communication assembly 816.

The processing assembly 802 generally controls integral operations of the computer device 800, such as operations related to displaying, a phone call, data communication, a camera operation, and a record operation. The processing assembly 802 may include one or more processors 820 to execute instructions, to complete all or some operations of the foregoing method. In addition, the processing assembly 802 may include one or more modules, to facilitate the interaction between the processing assembly 802 and other assemblies. For example, the processing assembly 802 may comprise a multimedia module, to facilitate the interaction between the multimedia assembly 808 and the processing assembly 802.

The memory 804 is configured to store data of various types to support operations on the computer device 800. Examples of the data includes instructions of any application program or method that are used for operations on the computer device 800, such as contact data, address book data, a message, a picture, and a video. The memory 804 can be implemented by any type of volatile or non-volatile storage devices or a combination thereof, such as a static random access memory (SRAM), an electrically erasable programmable read-only memory (EPROM), a programmable read-only memory (PROM), a read-only memory (ROM), a magnetic memory, a flash memory, a magnetic disc, or an optical disc.

The power supply assembly 806 provides power to various assemblies of the computer device 800. The power supply assembly 806 may include a power management system, one or more power supplies, and other assemblies associated with generating, managing, and distributing power for the computer device 800.

The multimedia assembly 808 includes a screen of an output interface provided between the computer device 800 and a user. In some embodiments, the screen may include a liquid crystal display (LCD) and a touch panel (TP). If the screen includes a TP, the screen may be implemented as a touchscreen, to receive an input signal from the user. The TP includes one or more touch sensors to sense touching, sliding, and gestures on the TP. The touch sensor may, in addition to sending the boundary of touching or sliding operations, also detect duration and pressure related to the touching or sliding operations. In some embodiments, the multimedia assembly 808 includes a front camera and/or a rear camera. When the computer device 800 is in an operating mode, such as a shooting mode or a video mode, the front camera and/or the rear camera may receive external multimedia data. Each front camera and rear camera may be a fixed optical lens system or have a focal length and an optical zooming capability.

The audio assembly 810 is configured to output and/or input an audio signal. For example, the audio assembly 810 includes a microphone (MIC). When the computer device 800 is in the operating mode, such as a call mode, a record mode, and a speech information processing mode, the microphone is configured to receive an external audio signal. The received audio signal may be further stored in the memory 804 or transmitted through the communication assembly 816. In some embodiments, the audio assembly 810 further includes a loudspeaker, configured to output an audio signal.

The I/O interface 812 provides an interface between the processing assembly 802 and an external interface module. The external interface module may be a keyboard, a click wheel, buttons, or the like. The buttons may include, but is not limited to: a homepage button, a volume button, a start-up button, and a locking button.

The sensor assembly 814 includes one or more sensors, configured to provide the computer device 800 with various aspects of state assessment. For example, the sensor assembly 814 may detect a powered-on/off state of the computer device 800 and relative positioning of assemblies. For example, the assemblies are a display and a keypad of the computer device 800. The sensor assembly 814 may further perform speech processing on changes in a location of the computer device 800 or an assembly of the computer device 800, a touch between the user and the computer device 800, an azimuth or acceleration/deceleration of the computer device 800 and changes in a temperature of the computer device 800. The sensor assembly 814 may include a proximity sensor, configured to detect the existence of nearby objects without any physical contact. The sensor assembly 814 may further include an optical sensor, such as a CMOS or CCD image sensor, that is used in an imaging application. In some embodiments, the sensor assembly 814 may further include an acceleration sensor, a gyroscope sensor, a magnetic sensor, a pressure sensor, or a temperature sensor.

The communication assembly 816 is configured to facilitate communication in a wired or wireless manner between the computer device 800 and other devices. The computer device 800 may access a communication standard-based wireless network, such as WiFi, 2G, or 3G, or a combination thereof. In an exemplary embodiment, the communication assembly 816 receives a broadcast signal or broadcast related information from an external broadcast management system through a broadcast channel. In an exemplary embodiment, the communication assembly 816 further includes a near field communication (NFC) module, to promote short range communication. For example, the NFC module may be implemented based on a radio frequency identification (RFID) technology, an infra-red data association (IrDA) technology, an ultra-wideband (UWB) technology, a Bluetooth (BT) technology, and other technologies.

In an exemplary embodiment, the computer device 800 may be implemented by using one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements, to perform the foregoing method.

In an exemplary embodiment, a non-transitory computer-readable storage medium including instructions, for example, a memory 804 including instructions, is further provided, and the instructions may be executed by the processor 820 of the computer device 800 to complete the foregoing method. For example, the non-transitory computer-readable storage medium may be a ROM, a random access memory (RAM), a CD-ROM, a magnetic tape, a floppy disk, an optical data storage device, or the like.

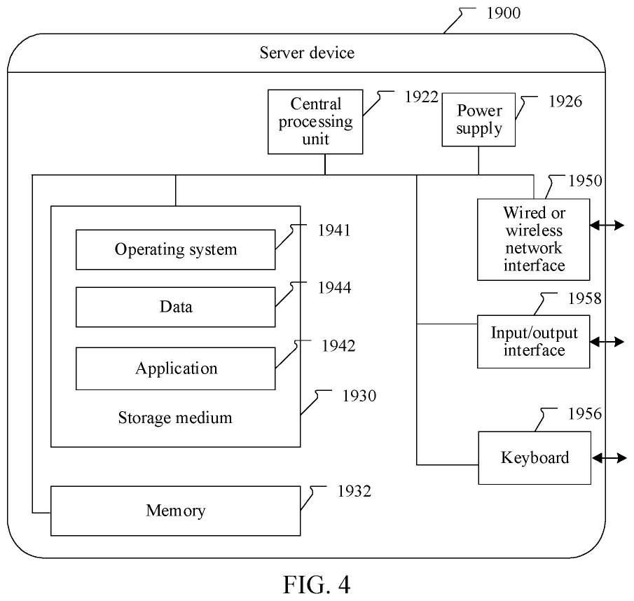

FIG. 4 is a schematic structural diagram of a computer device according to an embodiment of this disclosure. The computer device 1900, which may be a server or server device, may vary greatly due to different configurations or performance, and may include one or more central processing units (CPUs) 1922 (for example, one or more processors) and memories 1932, and one or more storage media 1930 (for example, one or more mass storage devices) storing an application 1942 or data 1944. The memory 1932 and the storage medium 1930 may be volatile or non-volatile storages. The program stored in the storage medium 1930 may include one or more modules (not shown in the figure), and each module may include a series of instructions and operations for the computer device. Furthermore, the CPU 1922 may be configured to: communicate with the storage medium 1930, and perform, on the computer device 1900, the series of instructions and operations in the storage medium 1930.

The computer device 1900 may further include one or more power supplies 1926, one or more wired or wireless network interfaces 1950, one or more input/output interfaces 1958, one or more keyboards 1956, and/or, one or more operating systems 1941, for example, Windows Server™, Mac OS X™, Unix™, Linux™, and FreeBSD™.

One or more non-volatile readable storage media are provided, storing computer-readable instructions, the computer-readable instructions, when executed by one or more processors, causing the one or more processors to perform operations of the foregoing data processing method.

A computer program product is provided, including computer-readable instructions, the computer-readable instructions, when being executed by a processor, implementing operations of the foregoing data processing method.

Persons skilled in the art can easily figure out another implementation solution of the issues disclosed herein after considering the disclosure and practicing the disclosed embodiments. This disclosure is intended to cover any variation, use, or adaptive change of this disclosure. These variations, uses, or adaptive changes follow the general principles of this disclosure and include common general knowledge or common technical means in the art that are not disclosed herein. The embodiments disclosed herein are considered as merely exemplary, and the scope and spirit of this disclosure are pointed out in the following claims.

It is to be understood that this disclosure is not limited to the precise structures described above and shown in the accompanying drawings, and various modifications and changes can be made without departing from the scope of the present disclosure. The scope of this disclosure is subject only to the appended claims.

The above are only preferred embodiments and are not intended to limit this disclosure. Any modification, equivalent replacement, or improvement made within the spirit and principle of this disclosure is included in the protection scope of this disclosure.

The data processing method, the data processing apparatus, and the computer device provided in the embodiments of this disclosure are described in detail above. The principle and implementations of this disclosure are described herein by using specific examples. The descriptions of the foregoing embodiments are merely used for helping understand the method and core ideas of this disclosure. In addition, persons of ordinary skill in the art can make variations and modifications in terms of the specific implementations according to the ideas of this disclosure. Therefore, the content of this disclosure shall not be construed as a limit thereto.

What is claimed is:

1. A data processing method, performed by at least one processor of a computer device and comprising:
obtaining sign language action data;
determining a sign language tagging sequence corresponding to the sign language action data by performing element analysis on the sign language action data, the element analysis being based on a pre-established sign language tagging system, the sign language tagging sequence comprising tagging information of basic sign language elements corresponding to the sign language action data; and
performing operation processing on the sign language action data based on the sign language tagging sequence.

2. The method according to claim 1, further comprising, prior to the performing of the element analysis:
establishing a sign language tagging system based on basic sign language elements and element types corresponding to each basic sign language element, the sign language tagging system comprising tagging information corresponding to the element types of each basic sign language element.

3. The method according to claim 2, wherein the basic sign language elements comprise at least one of a left or right arm feature, a one or both handshape feature, an orientation motion feature, a knuckle bending angle, a facial expression feature, or constraint information.

4. The method according to claim 2, wherein the establishing of the sign language tagging system comprises:
performing disassembly and classification on sign language action data in a database, to obtain the basic sign language elements and the element types corresponding to each basic sign language element.

5. The method according to claim 2, wherein the performing of the disassembly and of the classification comprises:
traversing the sign language action data in the database, performing action disassembly on the sign language action data, and determining a key part corresponding to each piece of the sign language action data and an action feature of the key part;
performing classification processing on the key part corresponding to each piece of the sign language action data in the database and the action feature of the key part, to obtain at least two class clusters, each class cluster corresponding to one basic sign language element; and
determining, based on an action feature of each class cluster, element types of a basic sign language element corresponding to the class cluster.

6. The method according to claim 5, wherein the action feature comprises at least one of rotation data, displacement data, a bending angle, a key feature, or an expression feature.

7. The method according to claim 1, wherein the determining of the sign language tagging sequence comprises:
performing the element analysis on the sign language action data, to determine a first basic sign language element corresponding to the sign language action data, and a first element type and a first timestamp of the first basic sign language element;
determining, based on the pre-established sign language tagging system, first tagging information of the first basic sign language element and second tagging information of the first element type; and
determining, based on the first timestamp, the first tagging information, and the second tagging information, the sign language tagging sequence corresponding to the sign language action data.

8. The method according to claim 1, wherein the performing of the operation processing comprises:
driving, based on the sign language tagging sequence, a pre-established three-dimensional character model to perform a sign language action corresponding to the sign language action data.

9. The method according to claim 1, wherein the performing of the operation processing comprises:
performing sign language translation processing on the sign language action data based on the sign language tagging sequence, to obtain a target text sequence corresponding to the sign language action data.

10. A data processing method, performed by a computer device and comprising:
performing word segmentation processing on a to-be-translated text sequence, to obtain a natural word sequence corresponding to the text sequence;
determining a basic sign language element corresponding to each natural word in the natural word sequence and an element type corresponding to the basic sign language element;
sorting the basic sign language element and the element type, to generate a sign language element sequence conforming to a sign language grammar rule;
determining a sign language tagging sequence corresponding to the sign language element sequence based on a sign language tagging system; and
performing sign language translation processing on the text sequence based on the sign language tagging sequence, to obtain a sign language action corresponding to the text sequence.

11. A data processing apparatus, comprising a memory and one or more processors, the memory storing computer-readable instructions, the computer-readable instructions, when executed by the one or more processors, causing the one or more processors to perform operations comprising:
obtaining sign language action data;
determining a sign language tagging sequence corresponding to the sign language action data by performing element analysis on the sign language action data, the element analysis being based on a pre-established sign language tagging system, the sign language tagging sequence comprising tagging information of basic sign language elements corresponding to the sign language action data; and
performing operation processing on the sign language action data based on the sign language tagging sequence.

12. The apparatus according to claim 11, wherein the computer-readable instructions further cause the one or more processors to perform operations of:
establishing a sign language tagging system based on basic sign language elements and element types corresponding to each basic sign language element, the sign language tagging system comprising tagging information corresponding to the element types of each basic sign language element.

13. The apparatus according to claim 12, wherein the basic sign language elements comprise at least one of a left or right arm feature, a one or both handshape feature, an orientation motion feature, a knuckle bending angle, a facial expression feature, or constraint information.

14. The apparatus according to claim 12, wherein the computer-readable instructions further cause the one or more processors to perform disassembly and classification on sign language action data in a database, to obtain the basic sign language elements and the element types corresponding to each basic sign language element.

15. The apparatus according to claim 12, wherein the computer-readable instructions cause the one or more processors to perform the disassembly and the classification by:
traversing the sign language action data in the database, performing action disassembly on the sign language action data, and determining a key part corresponding to each piece of the sign language action data and an action feature of the key part;
performing classification processing on the key part corresponding to each piece of the sign language action data in the database and the action feature of the key part, to obtain at least two class clusters, each class cluster corresponding to one basic sign language element; and
determining, based on an action feature of each class cluster, element types of a basic sign language element corresponding to the class cluster.

16. The apparatus according to claim 15, wherein the action feature comprises at least one of rotation data, displacement data, a bending angle, a key feature, or an expression feature.

17. The apparatus according to claim 11, wherein the computer-readable instructions cause the one or more processors to determine the sign language tagging sequence by:
performing the element analysis on the sign language action data, to determine a first basic sign language element corresponding to the sign language action data, and a first element type and a first timestamp of the first basic sign language element;
determining, based on the pre-established sign language tagging system, first tagging information of the first basic sign language element and second tagging information of the first element type; and
determining, based on the first timestamp, the first tagging information, and the second tagging information, the sign language tagging sequence corresponding to the sign language action data.

18. The apparatus according to claim 11, wherein the computer-readable instructions cause the one or more processors to perform the operation processing by:
driving, based on the sign language tagging sequence, a pre-established three-dimensional character model to perform a sign language action corresponding to the sign language action data.

19. The apparatus according to claim 11, wherein the computer-readable instructions cause the one or more processors to perform the operation processing by:
performing sign language translation processing on the sign language action data based on the sign language tagging sequence, to obtain a target text sequence corresponding to the sign language action data.
